(19) United States
(12) Patent Application Publication
(10) Pub. No.: US 2008/0170731 A1
(43) Pub. Date: Jul. 17, 2008

(54) Hearing Aid Momentary Switch Or Joystick As A Multifunction Acoustic Control

(75) Inventor: Tomasz Wojas, Manville, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS HEARING INSTRUMENTS INC., PISCATAWAY, NJ (US)

(21) Appl. No.: 11/622,505

(22) Filed: Jan. 12, 2007

(51) Int. Cl. H04R 25/00

(52) U.S. Cl. 381/312; 381/315

(57) ABSTRACT

A hearing instrument uses a single momentary switch or joystick to toggle programmable functions or value for each function. The length of the user actuation, short or long, can determine the action for internal circuit programming. The function change can be used in a circular or cyclical way, and the value range of each function can be programmed by specialized computer software. The present invention can replace plurality of controls used historically with one single component, which is very critical in building small hearing aids. The smaller faceplate area allows for better miniaturization and easier access for hearing aid users.

### BACKGROUND

In hearing aid design, one of the primary design criteria is the miniaturization of component parts. In known programmable hearing aids, control elements such as a volume control and a program changing switch (used by a user to select different programs, situational settings, or control parameters) are optionally provided, if such controls can be fitted on small area of the hearing aid faceplate. This is dependent upon the size of the customer shell and model requested.

In known non-programmable hearing aids, the volume control and various function controls/trimmers are assigned as separate hardware elements for each function; these further must conform with the size limitations in order to be able to fit on small area of faceplate. In general, even hearing aids having a large shell size can generally only accommodate a volume control and perhaps controls for two functions (from selection of four or five possible functions). It is desirable, however, to provide users with more control of functionality than is currently available with traditional designs. In the prior art, there are no devices having a volume control and pushbutton function replaced with one smaller momentary switch.

### SUMMARY

Accordingly, the present invention replaces a plurality of controls that have been used historically with one control having a functionality of the plurality of controls. These controls could include a volume control, a push-button for selecting hearing aid programs, and on/off switch, etc. Ideally, this control is designed to emphasize the greatest degree of minimization that is possible, since the size of components or controls that are used is a fundamentally critical criterion used in the construction of tiny hearing aids, and its use permits building smaller hearing aids than are currently on the market while also giving the user easy access to adjust some a larger number of acoustic functions. Additionally, the control can be designed as, e.g., a tiny switch with a handle that can be used as mechanical support for hearing aid and the handle having a graspable portion so that it can be used as a removal tool or mechanism to remove the hearing aid from customer's ear.

In a preferred embodiment, a momentary switch or a joystick is used to toggle between different program selections or programmable functions, and to adjust parameter values for each function. A momentary press or a press and hold can create a short or a long electrical pulse that determines an action for internal programming.

A number of functions can be implemented using the mechanism as described above. A programmed user setting can be read on a computer with specialized software and changed accordingly. This can occur using, e.g., by the hearing aid and computer exchanging pulsed data over a cable/flex strip having a special connector or tiny programming pins. This concept can also be implemented with the use of trimmers, which are small potentiometers, in a trimmer type hearing aid, in which a single component replaces two or more hardware trimmers.

### DESCRIPTION OF THE DRAWINGS

The invention is explained in more detail below with reference various preferred embodiments illustrated in the following drawings and appertaining description below.

FIG. 1 is a schematic diagram illustrating a momentary switch embodiment;

FIG. 2 is a schematic diagram illustrating a joystick utilizing a single IC control input pad embodiment; and

FIG. 3 is a schematic diagram illustrating a joystick utilizing a double IC control input pad embodiment.

### DETAILED DESCRIPTION OF THE PREFERRED EMBODIMENTS

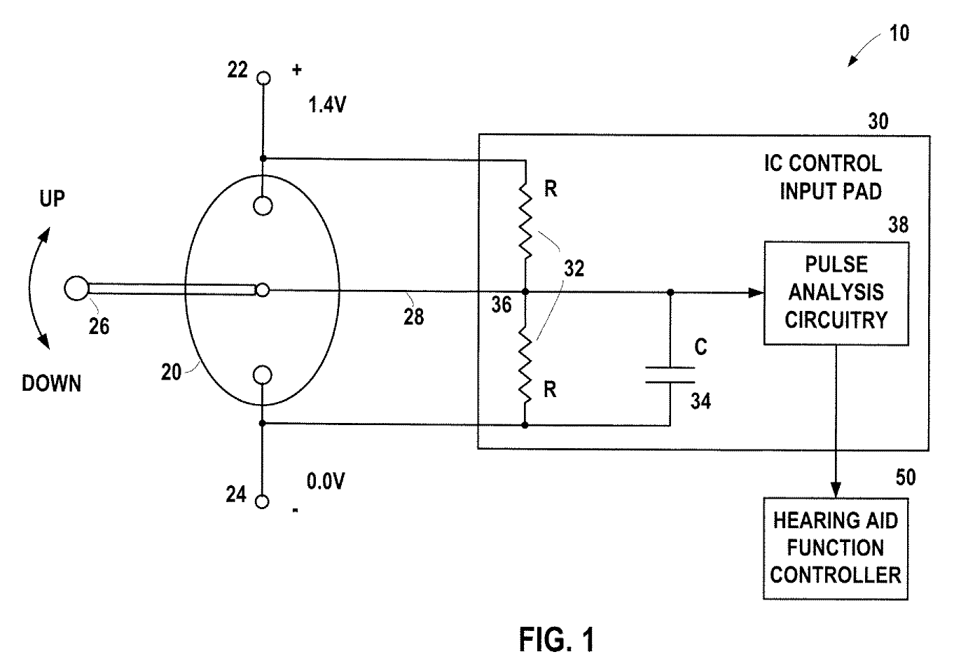

FIG. 1 illustrates an embodiment of the invention in which a momentary switch 20 with a toggle arm 26 can be moved along an up-down axis from a neutral center position. The switch is illustrated as a single-pole, double-throw (SPDT) switch, and, in the illustrated embodiment which could use a typical hearing aid voltage source (e.g., battery) of 1.4V, the three levels of voltage available are 0.0V, 0.7V (half of the power supply), and 1.4V. These different levels then permit the implementation, e.g., of a volume control or other function that can be changed up or down.

One pin from the switch 20 may be connected to the voltage supply, e.g., 1.4V, positive 22 and another pin from the switch 20 may be connected to a voltage supply negative 24 (e.g., ground, or 0.0V). A center pin 28 of the switch 20 is connected to a control input of an integrated circuit control input pad 30, in which an interface resistor divider 32 pre-polarizes a working point 36 to a mid supply voltage value (in the example presented, 0.7V). By way of example, a resistance R value may be on the order of 100 to 200 kΩ.

The capacitor 34 may be used as an anti-bouncing circuit to eliminate very short pulses resulting from mechanical vibrations of the contacts after moving the handle 26 from one position to the other. The capacitance of the capacitor 34 may be on the order of between 100 and 1000 pF. A debouncing capacitor or other circuitry is important for the IC control input pad 30 to properly interpret the correct number of incoming electrical pulses.

If the toggle handle 26 of the switch 20 is moved to an upper position, the positive voltage 22 is applied to the center pin 28, and if the toggle handle 26 of the switch 20 is moved to lower position, the negative voltage 24 is applied to the center pin 28. The IC control input 36 will interpret this positive or negative electrical pulse as a trigger to the proper function change.

The switch 20 can be operated via either short or long electrical pulses that are implemented via a pressing of the switch either up or down, and these pulses utilized to control the functionality. By way of a practical example that might be utilized for a user, a short electrical pulse may be in a range of 0.0 to 1.5 seconds in duration, and long electrical pulses may be in the range of >1.5 seconds of duration.

Referring to FIG. 1, a short electrical pulse from positive to negative can be interpreted as a volume control step up and down (default), whereas long electrical pulse can be interpreted as a program change up and down (e.g., from program 1 to program 2, etc.). Alternately, positive long electrical pulses can be interpreted as a program change up in a circular way (programs 1-2-3-4-1-2, etc.) and a negative electrical pulse can be interpreted as a power off-on circuit and/or battery life (or other) information. In an embodiment of the invention, battery life (or other feedback) information can be in the form of an acoustic signal such as a beep, musical tones and/or synthesized speech.

The pulse duration and other possible pulse attributes can be interpreted by pulse analysis circuitry 38, which can comprise, e.g., a comparator level circuit to detect a voltage level change direction and time counter circuit to measure pulse duration. The output of this pulse analysis circuitry 38 can interface with the hearing aid control 50 to change various function and parameter values.

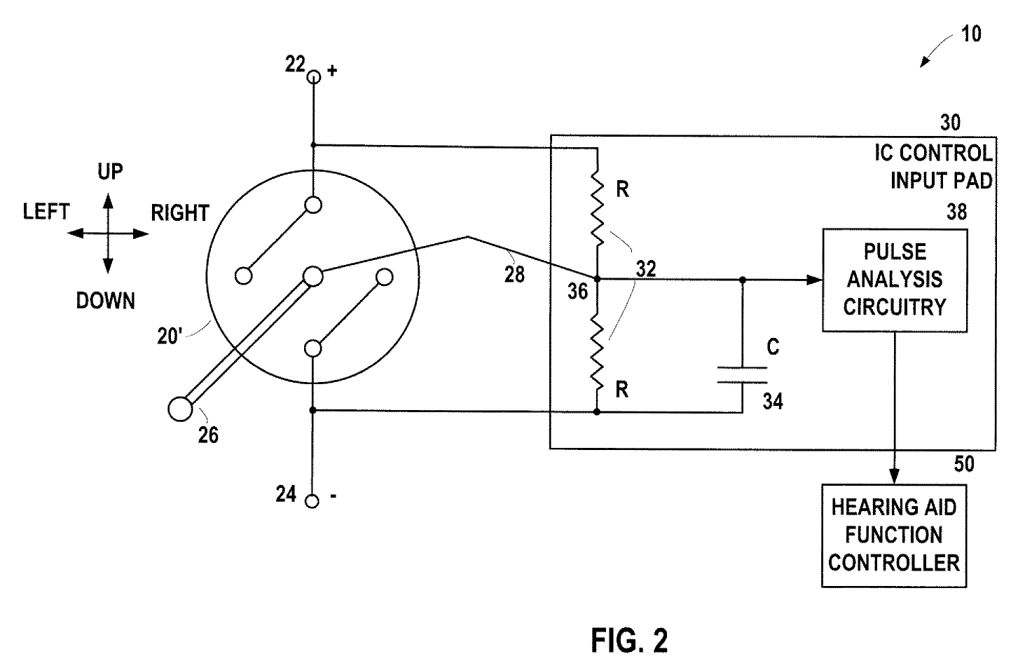

Referring to the joystick embodiment shown in FIG. 2, a similar functionality can be implemented as that provided by the switch illustrated in FIG. 1. Accordingly, short and long electrical pulses can control similar or identical functions described above, but can make use of a joystick type control capable of moving in two dimensions (left-right, and up-down). Note that in FIG. 2, there is only a single IC control input pad 30 that is controlled by the joystick toggle arm 26, and either a left or up movement will trigger a first connection, whereas a down or right movement will trigger a second connection. In this case, a similar analysis of short and long pulses can be implemented.

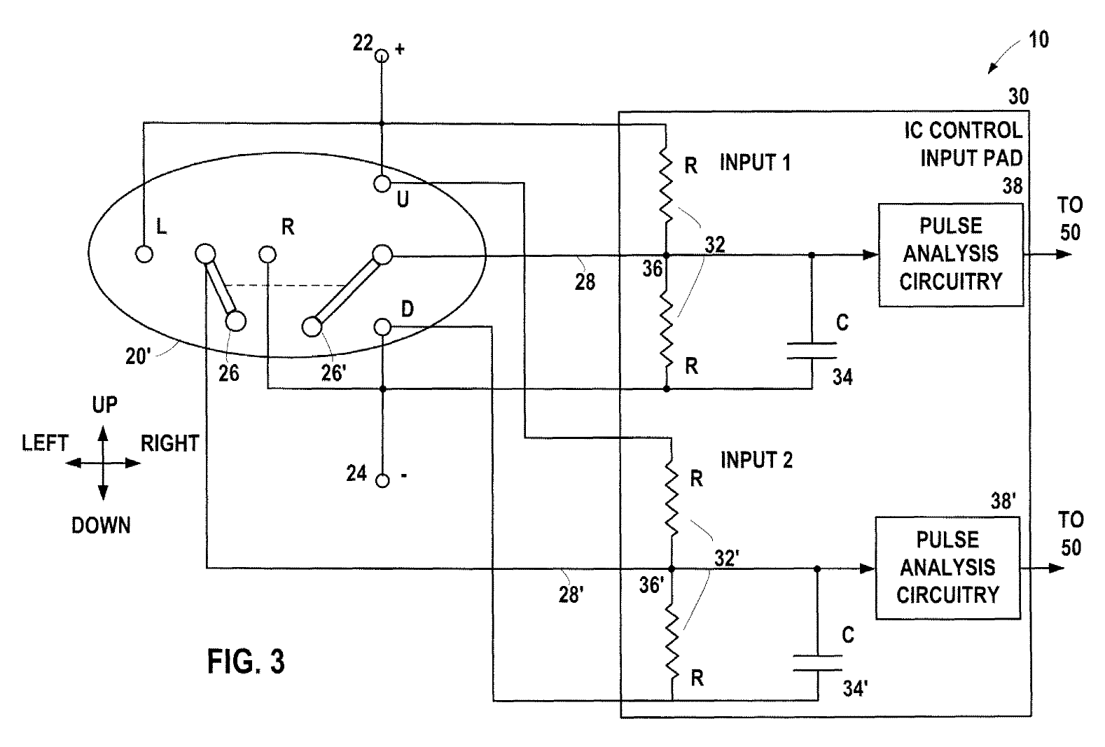

However, in another embodiment, as illustrated in FIG. 3, it may be desirable to control two different inputs depending on whether an up-down or left-right motion is utilized on the joystick. In this scenario, it is possible to use only pulses of a single duration (long or short) and let the horizontal or vertical direction of switching dictate the input and analysis. Or, depending on the tolerable level of user complexity, additional functionality could be achieved by utilizing a combination of long and short pulses in each direction, thereby doubling the amount of information that the joystick is capable of providing. Alternately, short pulses, e.g., could be allocated to up-down motion and long pulses could be allocated to left-right motion so as to make things clearer and simpler for the user.

The illustration in FIG. 3 shows two separate joysticks and respective toggle arms 26, 26′, one having an up-down motion, and another having a left-right motion, however, it is possible that a single control unit serves to operate the unit (in a manner analogous to a double-pole, double-throw switch)—what is important in this configuration is that there are two physically separate outputs of the switch to individually connect to INPUT 1 and INPUT 2 at working points 36, 36′. Alternately, a joystick having a common center pole, but different voltage supplies connected to the up-down and left-right pair of switches could be utilized, and thus the different voltage levels could be discerned by the pulse analysis circuitry.

By way of example, if the IC control input pad 30 has two controlling inputs INPUT 1, INPUT 2, short electrical pulses up-down can control volume control and long electrical pulses left-right can control memory switching function.

For non-programmable hearing aids, the idea can work in similar way as described above. For example, long electrical pulses can change basic functions, such as volume control VC, automatic gain control AGC, output control OUT, low frequency roll-off NH, high frequency roll-of NL, gain control GC, and short electrical pulse can, e.g., change a quantized step value for each function (typically the quantization is limited to eight to sixteen steps/levels).

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. Furthermore, the present invention could employ any number of conventional techniques for electronics configuration, signal processing and/or control, data processing and the like. The particular implementations shown and described herein are illustrative examples of the invention and are not intended to otherwise limit the scope of the invention in any way. For the sake of brevity, conventional electronics, control systems, and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### TABLE OF REFERENCE CHARACTERS

10 switch or joystick system
20, 20′ momentary switch
22 voltage supply positive
24 voltage supply negative
26,26′ toggle arm
28 center pin
30 control input pad
32, 32′ resistor divider
34, 34′ capacitor
36, 36′ working point
38, 38′ pulse analysis circuitry
50 hearing aid function controller

What is claimed is:

1. A method for controlling multiple hearing aid functions with a single control element, comprising:
connecting the control element to a voltage source to provide at least two different output levels;
actuating the control element by a user to provide a transition between the output levels in a form of a pulse having either a short duration or a long duration dependent upon the duration of the user actuation;
interpreting the short duration pulses as a step change in control of a first hearing aid function; and
interpreting the long duration pulses as control of a next hearing aid function.

2. The method according to claim 1, wherein the control element is a single-pole, double-throw switch.

3. The method according to claim 1, wherein the control element is a joystick, and the actuating of the control element is in a form of a left-right motion, or an up-down motion.

4. The method according to claim 1, wherein the voltage source is a battery having a voltage V, and three levels of voltage that are available are 0, ½ V, and V.

5. The method according to claim 1, further comprising:
connecting a center pin of the control element to a center of a voltage divider, and feeding a signal therefore to pulse analysis circuitry for the interpreting of the pulses.

6. The method according to claim 1, further comprising:
performing an anti-bouncing function on a signal produced by the control element.

7. The method according to claim 6, wherein the anti-bouncing function is performed with a capacitor connected in parallel with one of two resistors making up a voltage divider to which the control element is electrically attached.

8. A method for controlling multiple hearing aid functions with a single control element, comprising:
connecting the control element to a voltage source to provide at least two different output levels;
actuating the control element by a user to provide a transition between the output levels in a form of a pulse having a duration dependent upon the duration of the user actuation, the actuation being performed in an up-down direction pair, and a left-right direction pair;
interpreting the pulses from the up-down direction pair actuation as a step change in control of a first hearing aid function; and
interpreting the pulses from the left-right direction pair actuation as control of a next hearing aid function.

9. The method according to claim 8, further comprising:
interpreting only long-duration pulses from one direction pair actuation, and interpreting only short-duration pulses from the other direction pair actuation.

10. The method according to claim 1, further comprising:
utilizing a handle of the control element as a support for the hearing aid; and
removing the hearing aid from a user's ear with the handle.

11. A hearing aid control mechanism, comprising:
a momentary contact switch connected to a voltage supply and having an output at which at least a first and a second voltage level are provided, the switch comprising:
an actuator operable by a user that, when actuated, creates the first voltage level at a switch output, and when not actuated, creates the second voltage level at the switch output, thereby producing a pulse at the output;
the control mechanism further comprising:
a pulse analysis circuit comprising:
an input connected to the switch output that distinguishes between short-duration pulses and long-duration pulses produced at the switch output; and
an output connected to a function controller of the hearing aid for controlling two or more functions of the hearing aid dependant upon pulse duration.

12. The mechanism according to claim 11, wherein the control element is a single-pole, double-throw switch.

13. The mechanism according to claim 11, wherein the control element is a joystick capable of moving in an up-down motion or a left-right motion for actuation.

14. The mechanism according to claim 11, wherein the voltage source is a battery having a voltage V, and three levels of voltage that are available are 0, ½ V, and V.

15. The mechanism according to claim 11, further comprising:
a voltage divider circuit comprising two resistors serially-connected at a central point; and
a center pin of the control element that is connected to the central point of the voltage divider and is further connected to the input of the pulse analysis circuitry.

16. The mechanism according to claim 11, further comprising:
anti-bounce circuitry connected to the input of the pulse analysis circuit.

17. The mechanism according to claim 16, wherein the anti-bounce circuitry comprises a capacitor as its sole or primary component.

18. The mechanism according to claim 11, wherein the pulse analysis circuit comprises:
a comparator level circuit to detect a voltage level change direction at the pulse analysis circuit input; and
a time counter circuit to measure a pulse duration at the pulse analysis circuit input.

19. The mechanism according to claim 11, wherein the control mechanism further comprises a handle with a graspable portion for removal of the hearing aid from the ear.

20. A hearing aid control mechanism, comprising:
a joystick control element that can be moved in an up-down direction and a left-right direction, having a first output and a second output at which at least a first and a second voltage level are provided, the joystick comprising:
an actuator operable by a user that, when actuated in an up-down motion, creates the first voltage level at the first joystick output and when not actuated creates the second voltage level at the first joystick output, and when actuated in a left-right motion, creates the first voltage level at the second joystick output, and when not actuated, creates the second voltage level at the second joystick output;
the control mechanism further comprising:
a first pulse analysis circuit comprising:
an input connected to the first switch output that reads pulses produced at the first switch output; and
an output connected to a first function controller of the hearing aid for controlling a first function of the hearing aid; and
a second pulse analysis circuit comprising:
an input connected to the second switch output that reads pulses produced at the second switch output; and
an output connected to a second function controller of the hearing aid for controlling a next function of the hearing aid.

21. A mechanism for controlling multiple hearing aid functions with a single control element, comprising:
a momentary contact means for producing, at an output, a pulsed first and second voltage level;
an analysis means for distinguishing between short-duration pulses and long duration pulses provided by the momentary contact means; and
means for controlling two or more functions of the hearing aid dependent upon pulse duration.
